(19) United States
(12) Patent Application Publication
(10) Pub. No.: US 2020/0029613 A1
(43) Pub. Date: Jan. 30, 2020

(54) FROZEN CONFECTION

(71) Applicant: Ben & Jerry's Homemade, Inc., South Burlington, VT (US)

(72) Inventors: Kirsten Anne SCHIMOLER, London (GB); Paulina Janina SKRZESZEWSKA-HOFS, 2804 WZ Gouda (NL)

(73) Assignee: Ben & Jerry's Homemade, Inc., South Burlington, VT (US)

(21) Appl. No.: 15/738,461

(22) PCT Filed: Jun. 22, 2016
(86) PCT No.: PCT/EP2016/064469

§ 371 Date: Dec. 20, 2017

Related U.S. Application Data
(60) Provisional application No. 62/186,808, filed on Jun. 30, 2015.

(51) Int. Cl. A23L 33/185; A23G 9/32; A23G 9/42

(52) U.S. Cl. CPC A23L 33/185; A23G 9/327; A23V 2250/60; A23V 2250/184; A23V 2250/548; A23G 9/42

(57) ABSTRACT

A frozen confection which need not include any ingredients of animal origin, such as milk ingredients, and yet which provides the indulgent sensory experience of ice cream. The experience is reflected in excellent texture, mouth feel and melt profile. The compositions of the invention include a saturated oil, such as coconut oil, a vegetable protein such as pea protein, nut solids such as almond solids, sugar solids and optionally an emulsifier and/or a stabilizer. More specifically, the frozen confection of the invention comprises 6-10 wt % saturated oil, 0.5-4 wt % vegetable protein, 1-8 wt % nut solids, 10-25 wt % sugar solids and 0-1 wt % emulsifier and 0-1 wt % stabilizer.

### BACKGROUND OF THE INVENTION

### Field of the Invention

Frozen confections, such as ice cream, are much enjoyed by consumers. However, the typical frozen confection product is not ideally suited to some consumers' goals because many frozen confections contain milk-based ingredients such as milk fat, milk protein and milk sugar.

Some consumers try to avoid milk-based ingredients because of allergies or intolerances. Others prefer to avoid animal based products for ethical reasons. Still others are concerned about the levels of cholesterol and saturated fat in milk and cream. Others prefer more environmentally sustainable ingredients than diary ingredients. Finally, some consumers would prefer products made from less expensive ingredients.

Frozen confections or other food products wherein part or all of dairy ingredients have been replaced have been described in the patent literature, including Cox, et al. EP 1967077, Medina et al. WO2014/008580, Tergesen US Patent Application Publication No. US2014/0255591, Boursier et al. US Patent Application Publication No. US2011/0305740, Perks et al. WO2009/023560, Eisner et al. US Patent Application Publication No. US2008/0089990, CN103859129, Samoto et al. US Patent Application Publication No. US2014/0113866, Bilet US 2012/0121775, Colavito US 2011/0206808. Colavito WO 2013/019771, Carella et al. US 2014/0271993, Crank WO 2007/103753, Sabbagh et al. WO 2010/033985, CN 103349148, Jarrett WO 2006/096377, Eisner et al. US 2009/0011107, Back et al. US 2006/0127560, Tsujii et al. US 20070128323, CN102028089, WO 2009/063458, JP2006158391, Tabuteau et al. GB 2194877, JP11276086, Snowden et al. US 2007/0154611, CN1685920, Crank et al. WO 97/37547, Leusner et al. U.S. Pat. No. 4,696,826, and WO 86/02809.

Frozen confections or other food products wherein part or all of dairy ingredients have been replaced have been described in the non-patent technical literature as well, including Slind-Flop, “A new scoop for chef Leruth,” Restaurant Business (1986), Volume 85, Number 8, pp. 154-155, Simmons et al., “Cottonseed and soya protein ingredients in soft-serve frozen desserts,” Journal of Food Science, 1980, 45 (6), 1505-8, Lawhon, et al. Utilisation of membrane-produced oilseed isolates in soft serve frozen desserts, Journal of the American Oil Chemists' Society, 1980, 57 (9), 302-6, Lightowler, et al., The Vegan Dairy, Nutrition and Food Science, 1998, (May-June), (3), 153-157, Ahanian, “Production of Ice Cream by Using Soy Milk, Stevia and Isomalt,” Advances in Environmental Biology (2014), 8(11S5), 9-16, Bisla, et al. “Development of ice-creams from soyabean milk & watermelon seeds milk and evaluation of their acceptability and nourishing potential,” Advances in Applied Science Research (2012), 3(1), 371-376, and Iguttia, et al. “Substitution of ingredients by green coconut (Cocos nucifera L) pulp in ice cream formulation,” Procedia Food Science (2011), 1, 1610-1617.

Other literature includes Pereira, et al., “Influence of the partial substitution of skim milk powder for soy extract on ice cream structure and quality,” European Food Research and Technology (2011), 232(6), 1093-1102, Anon, “ADM offers soy as dairy protein alternative,” Decision News Media, 2007, (November 14), Kebary et al, “Quality of ice cream as influenced by substituting non-fat dry milk with whey-bean proteins coprecipitates,” Egyptian Journal of Dairy Science (1997), Volume 25, Number 2, pp. 311-325, Anon, “Indulgent ice-cream,” Dairy Foods, 1994, 95 (6), 86, LaBell, “Multi-use milk substitute,” Food Processing, USA (1991), Volume 52, Number 11, pp. 118-120, Gupta, et al., “Fabricated dairy products,” Indian Dairyman (1987), Volume 39, Number 5, pp. 199-208, Regan, “Ben & Jerry Are Going to Make Non-Diary Ice Cream Flavors,” Time Magazine (Jun. 16, 2015), P1, and Hannigan, “Corn/soy-based frozen desserts: taste and nutrition made to order,” Food Engineering (1982), Volume 54, Number 3, 92 p.

Several nut-based frozen desserts are on the market in the United States, including So-Delicious Almond Milk Frozen Dessert (ingredients include almond milk (water, almonds), organic dried cane syrup, coconut oil, vanilla extract, natural flavor, gum arabic, carob bean gum, sea salt) and Almond Dream Non-Dairy Frozen Dessert (ingredients include filtered water, evaporated cane juice, almonds, expeller pressed oil (sunflower and/or safflower and/or canola), tapioca maltodextrin, natural vanilla extract, potato starch, guar gum, carob bean gum, carrageenan, soy lecithin, sea salt, natural flavors).

Despite the many disclosures of frozen confections in which milk ingredients are fully or partly replaced, there is still a need for a frozen confection which more closely imitates ice cream.

### SUMMARY OF THE INVENTION

The invention is directed to a frozen confection which need not include any ingredients of animal origin, such as milk ingredients, and yet which provides the indulgent sensory experience of ice cream. The experience is reflected in excellent texture, mouth feel and melt profile. The compositions of the invention include a saturated oil, such as coconut oil, a vegetable protein such as pea protein, nut solids such as almond solids, sugar solids and optionally an emulsifier and/or a stabilizer. The invention also relates to a process for making the product, as described herein. More specifically, the frozen confection of the invention comprises 6-10 wt %, preferably 7-8 wt %, saturated oil, e.g., coconut oil, 0.5-4 wt % vegetable protein, e.g., pea protein, 1-8 wt % nut solids, e.g., almond solids, 10-25 wt % sugar solids and 0-1 wt % emulsifier and 0-1 wt % stabilizer.

Ingredients from animal sources, such as milk, are not required for compositions of the invention; the compositions are preferably essentially free of ingredients from animal sources such as dairy, most preferably completely free of ingredients from animal sources such as dairy ingredients. Especially preferred is that the compositions are essentially free of milk proteins. Thus, the products of the invention will have special appeal to consumers who have milk allergies or intolerances, who prefer not to eat animal-based products, who are concerned about the levels of cholesterol and saturated fat in milk, and who prefer products made from more sustainable ingredients. In addition, the plant-based ingredients used in the present compositions tend to be easier to obtain and less expensive than milk ingredients.

For those who wish to avoid soy, it is preferred that the products of the invention are essentially free of soy ingredients, as well.

For a more complete of the above and other features and advantages of the invention, reference should be made to the following description of the preferred embodiment.

### DETAILED DESCRIPTION OF THE INVENTION

As used herein, “nuts” refer to a seed which comes from within a hard shell. Although technically categorized as a legume, for the purpose of this application, peanuts shall be considered a nut rather than a legume/vegetable. Nuts shall not be considered to be a “vegetable” in the present application. Therefore, as used herein, “vegetable protein” does not include protein derived from nuts. As used herein, “vegetable” refers to plant material that is not a fruit, a seed or a nut.

The frozen confection is a frozen product such as ice cream, sherbet, water ice and the like. “Frozen,” as used herein, denotes that the product is solidified under freezing conditions to a hardpack or pumpable consistency which is not fluid or semi-fluid. The ice content of the frozen confection should be more than 15% but less than 45% when measured at −18° C. The frozen confection is preferably a water-continuous emulsion.

By “base frozen confection” is meant the frozen confection but not including ingredients which will exist non-homogeneously in the confection, e.g., inclusions, such as visibly identifiable viscous flavorings like fudge and caramel swirls, nut pieces, cookie dough pieces, fruit pieces, baked pieces, candies, etc. The finished product is from 70% to 100% mix or base frozen confection, depending on the level of flavorings or inclusions. Inclusions (not part of the frozen matrix formed by the mix) range from 0 to 30 wt %, especially from 0.5 wt % to 30 wt %, preferably from 10% to 30 wt % of the frozen confection. Flavorings may be in the range of 0.01 to 20% wt of the frozen confection.

The pH of the frozen confections of the invention are typically 5 or above, especially 5.5-7.5, more preferably 5.5-7.3.

The frozen confection of the invention is preferably aerated, i.e., it has an overrun of more than 20 percent and preferably less than 200%. Most preferably the product is a super premium product having an overrun of from 20-40%.

Overrun is defined by the equation below and is measured at atmospheric pressure:

Overrun %=((density of mix−density of frozen confection)/density of frozen confection)×100.

The base frozen confections of the invention include from 0.5 to 4 wt % vegetable protein, especially from 1 to 2 wt % vegetable protein. Types of vegetable protein which may be used herein include, but are not limited to, the following and combinations thereof: pea protein, chickpea beans, soy protein, wheat protein, cotton seed protein, sunflower seed, lupin protein, oat protein, lentil protein, sesame seed protein, broad bean protein, horse bean protein, alfalfa protein, clover protein, rice protein, tapioca protein, potato protein, carob protein and corn protein. Pea protein is especially preferred. Preferably, the vegetable proteins of the invention are not fermented. Advantageously, the level of total protein including vegetable and any other proteins, such as protein contributed by nut solids, is within the range of 1-4 wt %, especially 1-2 wt %.

The vegetable protein is preferably added in the form of a powder, agglomerate or paste. Preferably the powder, agglomerate or paste, or other form in which the vegetable protein is added, is essentially free of starch hydrolyzate.

Preferably the base frozen confection is essentially free of protein hydrolyzates.

The base mix of the frozen confections of the invention include from 1-8 wt % of nut solids. Sources for nut solids include almonds, cashews, pecans, peanuts, macadamia nuts, brazil nuts, pine nuts, coconuts, butternuts, hazelnuts, walnuts, beechnuts, hickory nuts, chestnuts, pistachios, and mixtures thereof. Almonds are preferred.

The nut solids may be added to the liquid base mix pre-freezing in the forms such as ground nuts, nut paste or nut butter. Almond paste is preferred.

Generally the product of the invention will not include ingredients from an animal source, such as a dairy source. In some cases, however, it may be desirable to include a dairy source, such as whole milk, skim milk, condensed milk, evaporated milk, cream, butter, butterfat, whey, milk solids non-fat, etc. If present, the dairy source may contribute dairy fat and/or non-fat milk solids such as lactose and milk proteins, e.g. whey proteins and caseins. A dairy protein powder, such as whey protein, may be used as a protein source.

If it is desired to include a milk sugar, lactose may be present in the base frozen confections used in the invention within the range of from 0 to 8 wt percent, especially from 0.5 to 7 percent, more preferably from 3 to 8 wt percent. If desired, dairy proteins will generally be present in the base frozen confections of the invention at from 1 to 5 wt percent, especially from 1 to 3 wt percent.

The base frozen confection includes from 6-10 wt % saturated oil. By saturated oils is meant oils and fats having at least 30 wt % of their fatty acid moieties as saturated fatty acids. Saturated oils include, but are not limited to coconut, cocoa butter, illipe, shea, palm, palm kernel, and sal and mixtures thereof. Coconut oil is preferred.

While saturated vegetable oils are preferred, butter fat from cream and other dairy sources may also be used if the product is not to be dairy free.

If it is desired to include oils and fats other than saturated oils, these may include, for instance, soybean oil, corn oil, peanut oil, safflower oil, flaxseed oil, cottonseed oil, rapeseed oil, canola oil, olive oil, sunflower oil, high oleic sunflower oil, and mixtures thereof.

The level of triglyceride fat in the base frozen confection product, indeed preferably the total level of digestible lipid in the base frozen confection product, is preferably from 1 weight percent to 20 wt %, more preferably, from 3 wt % to 8 wt %.

If desired, the product may include an emulsifying agent. Typical emulsifying agents may be phospholipids such as soybean or sunflower lecithin, and proteins, such as dairy or soy proteins, or esters of long chain fatty acids and a polyhydric alcohol. Fatty acid esters of glycerol, polyglycerol esters of fatty acids, sorbitan esters of fatty acids and polyoxyethylene and polyoxypropylene esters of fatty acids may be used but organoleptic properties, or course, must be considered. Eggs and other animal sourced emulsifying ingredients may be used as emulsifying agents but are not preferred given the desire to eliminate ingredients from animal sources. Mono- and di-glycerides may also be used but may also be omitted. Indeed, emulsifiers other than proteins may be omitted. If present, non-protein emulsifiers are used in amounts of 0 to 1 wt %, preferably 0.1 to 1%, especially 0.03 percent to 0.5 percent, more preferably 0.1 percent to 0.3 percent by weight of the base frozen confection.

Gum stabilizers are particularly effective in controlling viscosity, providing mouth feel and improving whipping (aerating) properties; to provide a protective colloid to stabilize proteins to heat processing; to modify the surface chemistry of fat surfaces to minimize creaming; to provide acid stability to protein systems and; to increase freeze-thaw stability. Gums can be classified as neutral and acidic, straight- and branched-chain, gelling and non-gelling. The principal gums that may be used are Karaya gums, locust bean gum, carageenan, xanthan, guar, alginate and carboxymethyl cellulose.

Gums are generally used in concentrations of 0-1 wt %, especially 0.1-1 wt %, preferably 0.02-0.5 weight percent of the base frozen confection composition. Because of differing functionalities, combinations of certain gums may provide a better product than a single gum.

The stabilizer may be microcrystalline cellulose as described in U.S. Pat. No. 5,209,942, e.g., Avicel 581, which is activated or “peptized.” A combination of microcrystalline cellulose and sodium carboxymethyl cellulose (CMC) may give good results.

Microcrystalline cellulose has been listed in the Fourth Supplement to the Food Chemicals Codex, First Edition, by the National Academy of Sciences-National research Council as: Cellulose, Microcrystalline (cellulose gel). Cellulose gel in combination with cellulose gum is especially preferred.

Other stabilizes which may be used include citrus fiber, at a level of between 0.1-1 wt %.

Another component may comprise one or any combination of carboxymethylcellulose (in addition to that with which the microcrystalline cellulose may be coated), xanthan gum, starch and alginate.

If desired, and animal-derived ingredients are acceptable, gelatin, e.g., 225 bloom, may be included in the base frozen confection compositions at levels of say 0.1-1 wt percent, especially from 0.1-0.3 wt percent.

Certain salts such as phosphates and chlorides may be employed to alter the buffering capacity of the system and to improve the water binding capacity of proteins and improve solubility and flavor. Sodium chloride and sodium monophosphate at very low levels are preferred but calcium phosphate and particularly monocalcium phosphate may also be employed. Sodium chloride is preferred at levels of 0.05 percent to 0.3 percent of the base frozen confection; and sodium monophosphate is preferred at levels of 0.01 percent to 0.1 percent of the base frozen confection.

Generally the compositions of the invention will be naturally sweetened. Natural sources of sweetness include sucrose (liquid or solids), glucose, fructose, and corn syrup (liquid or solids). Other sweeteners include lactose, maltose, and galactose. Levels of sugars and sugar sources preferably result in sugar solids levels of up to 30 wt percent in the base frozen confection, preferably from 10 to 25 wt percent.

If it is desired to use artificial sweeteners, any of the artificial sweeteners well known in the art may be used, such as aspartame, saccharine, Alitame (obtainable from Pfizer), acesulfame K (obtainable from Hoechst), cyclamates, neotame, sucralose and the like, and mixtures thereof. The sweeteners are used in varying amounts of about 0.005 percent to 1 percent of the base frozen confection, preferably 0.007 wt percent to 0.73 wt percent depending on the sweetener, for example. Aspartame may be used at a level of 0.01 wt percent to 0.15 wt percent of the base frozen confection, preferably at a level of 0.01 wt percent to 0.05 wt percent. Acesulfame K is preferred at a level of 0.01 wt percent to 0.15 wt percent of the base frozen confection.

Natural low- or non-caloric sweeteners such as stevia may be used at levels of from 0.01 to 0.15 wt %, especially 0.01 to 0.05 wt % of the base frozen confection. However, it is more preferred that the compositions of the invention are free of intense sweeteners (e.g., 10× or more sweetness than sucrose, especially 100× or more sweetness than sucrose) such as artificial sweeteners and stevia.

If desired, the product may include polydextrose. Polydextrose functions both as a bulking agent and as a fiber source and, if included, may be present at from 1 to 10 wt percent, especially from 3 to 6 wt percent of the base frozen confection.

Polydextrose may be obtained under the brand name Litesse from Danisco Sweeteners. Among other fiber sources which may be included in the compositions of the invention are fructose oligosaccharides such as inulin. Additional bulking agents which may be used include maltodextrin, sugar alcohols, corn syrup solids, sugars or starches. Total bulking agent levels in the base frozen confections of the invention, excluding any sugars or corn syrup solids, which are included with sweeteners above, may be from about 5 percent to 20 wt percent, preferably 13 percent to 16 wt percent. If desired, Sugar alcohols such as glycerol, sorbitol, lactatol, maltitol, mannitol, etc. may also be used to control ice formation. However, the present invention also contemplates formulations in which glycerol is excluded.

Flavorings may be included in the frozen confection of the invention, preferably in amounts that will impart a mild, pleasant flavor. The flavoring may be any of the commercial flavors employed in ice cream, such as varying types of cocoa, pure vanilla or artificial flavor, such as vanillin, ethyl vanillin, chocolate, extracts, spices and the like. It will further be appreciated that many flavor variations may be obtained by combinations of the basic flavors. The confection compositions are flavored to taste. Suitable flavorants may also include seasoning, such as salt, and imitation fruit or chocolate flavors either singly or in any suitable combination.

Malt powder can be used, e.g., to impart flavor, preferably at levels of from 0.01 to 3.0 wt percent of the base frozen confection, especially from 0.05 to 1 wt percent.

Preservatives such as potassium sorbate may be used as desired.

Adjuncts such as wafers, variegates, e.g., viscous, free oil-containing flavorings and sauces/coatings may be included as desired. Some of these may be in the form of inclusions such as viscous flavorings like fudge and caramel, nut pieces, cookie dough pieces, fruit pieces, dark and/or milk chocolate chunks, etc. Inclusions (not part of the frozen matrix formed by the mix) range from 10% to 30 wt % of the frozen confection. Flavorings may be in the range of 0.01 to 20% wt of the frozen confection.

Water/moisture/ice will generally constitute the balance of the base frozen confection at, e.g., from 40-90 wt %, especially from 50-75 wt %.

In terms of the microstructure, the protein should enable the creation of a fine microstructure where the average bubble diameter is between 20 and 200 um, preferably between 20 and 150 um and most preferably between 20 and 100 um in the produced ice cream product after hardening to below −18° C.

The emulsion droplet size D[0, 5] for a mix reflects good structure. Notably, mixes exhibiting a D[0,5] of greater than 0.2 and less than 1.19 μm, especially less than 1.16, show a good microstructure and are preferred herein.

Preferably, vegetable oils/fats used in the present invention are not partially hydrogenated. Fat which has been hydrogenated to an extent such that there are still more than 2 wt % of unsaturated fatty acid moieties in the fat are considered partially hydrogenated herein. Even fully hydrogenated fats (fats hydrogenated so that there are 2 wt % or fewer unsaturated fatty acid moieties in the fat) are not preferred but may be used as ingredients in the composition in certain cases. The compositions of the invention preferably are essentially free, more preferably completely free, of hydrogenated fats, especially partially hydrogenated fats. Hydrogenation of fats refers to the process wherein fats are chemically reacted by human intervention to replace one or more double bonds with hydrogen atoms.

All percentages herein are by weight unless otherwise stated or clearly required by context. Unless otherwise stated or clearly required by context, percentages are by weight of the base frozen confection.

By “essentially free” herein it is mean that the indicated ingredient is present at a level of 0.1 wt % or less of the base frozen confection.

Processes used for the manufacture of the product are similar to those used for conventional frozen confections. Typical process steps include: ingredient blending, pumping, pasteurization, homogenization, cooking, aeration, packaging and freezing.

Products can be manufactured by batch or by continuous processes, preferably continuous. Ingredients may be either liquid or dry, or a combination of both. Liquid ingredients can be blended by the use of positive metering pumps to a mixing tank or by in-line blending. Dry ingredients must be hydrated during the blending operations. This is most commonly accomplished by the use of turbine mixers in processing vats or by incorporating the dry material through a high speed, centrifugal pump. The blending temperature depends upon the nature of the ingredients, but it must be above the melting point of any fat and sufficient to fully hydrate proteins and any gums used as stabilizers.

Pasteurization is generally carried out in high temperature short time (HTST) units, in which the homogenizer is integrated into the pasteurization system. Protein is advisedly fully hydrated before adding other components which might interfere with the hydration.

### EXAMPLES 1 and 2

Mix Formulas

| | |
|---|---|
| White Mix (Example 1) | Chocolate Mix (Example 2) |
| wt % | wt % |

| | | | |
|---|---|---|---|
| Coconut oil | 8 | Coconut oil | 7 |
| Liquid Sugar FT | 25 | Liquid Sugar FT | 25.5 |
| Corn Syrup Solids | 7.5 | Corn Syrup Solids | 2 |
| Almond Paste | 4 | Almond Paste | 4 |
| Pea Protein | 1 | Pea Protein | 1 |
| Sunflower Lecithin | 0.5 | Sunflower Lecithin | 0.45 |
| Guar Gum | 0.1 | Guar Gum | 0.1 |
| Locust Bean Gum | 0.09 | Locust Bean Gum | 0.08 |
| | | FT cocoa 20/22 | 5 |
| Water, Municipal | 54 | Water, Municipal | 54.6 |

Examples 1 and 2 are prepared by mixing the following ingredients in the following order. Water is heated to 85° C. Subsequent ingredients are added at from 70-75° C. The product is made by adding (water, sugars, stabilizer, protein) almonds and then emulsifier and coconut oil (i.e. stabilisers added at the start of the process and fats at the end); pasteurising; homogenizing; filling in tubs at 4-5° C.; freezing at 20 to −25° C.

Processing Information

| | Temperature | |
|---|---|---|
| Ingredients | C. ° | F. ° |
| Water | 85 | |
| Sucrose(dry) + Stablizers + Pea Protein | 75 | |
| Corn Syrup Solids | | |
| Cocoa Powder | | |
| Almond Paste | | |
| Sunflower Lecithin | | |
| Coconut Oil | | |
| Final Tank Temp | 72 | |
| Pasteurization Temp. (T: 25 s) | 84.4 | |
| Mix out Temp | 9.9 | |

| Homogenization Pressure | Bar |
|---|---|
| Stage 1 | 250 |
| Stage 2 | 30 |

| | g/l |
|---|---|
| Density | 1.1 |
| Freezer Temp | −4.5 |
| Condenser | 45% |
| Speed | 30% |
| Flow | 0.6 l/min |

### EXAMPLE 3

| Ingredient | White Mix |
|---|---|
| Coconut oil | 10% |
| Almond | 4% |
| sucrose | 17.5% |
| guar gum | 0.1% |
| Lbg | 0.07% |
| sunflower lecithin | 0.5% |
| pea protein | 2% |
| water | 66% |
| | 100% |

The composition is sweet, soft, creamier and less icy. Some Consumers may prefer a less sweet formulation. The composition looks like ice cream.

### EXAMPLE 4

| Ingredient | Chocolate Mix |
|---|---|
| Coconut oil | 8% |
| Almond | 3% |
| sucrose | 17.5% |
| guar gum | 0.1% |
| lbg | 0.07% |
| sunflower lecithin | 0.7% |
| pea protein | 1.5% |
| Cocoa | 5.5% |
| water | 64% |
| | 100% |

The composition has a good flavor delivery.

### EXAMPLE 5

| Ingredient | White Mix |
|---|---|
| Coconut oil | 10% |
| Almond | 4% |
| sucrose | 16% |
| 28 DE glucose | 2% |
| guar gum | 0.1% |
| lbg | 0.08% |
| sunflower lecithin | 0.5% |
| pea protein | 1.5% |
| water | 66% |
| | 100% |

The composition is lighter in color, very sweet, and slightly nutty. It has a creamy mouthfeel. It has a slightly faster melt with more “pull.

### EXAMPLE 6

| Ingredient | White Mix |
|---|---|
| Coconut oil | 10% |
| Almond | 3% |
| sucrose | 17% |
| 28 DE glucose | 4% |
| guar gum | 0.1% |
| lbg | 0.08% |
| sunflower lecithin | 0.5% |
| pea protein | 1% |
| water | 64% |
| | 100% |

This formula felt most close to ice cream.

### EXAMPLE 7

| Ingredient | White Mix |
|---|---|
| Coconut oil | 12% |
| sucrose | 13% |
| 28 DE glucose | 5% |
| guar gum | 0.08% |
| lbg | 0.12% |
| citrus fiber | 0.5% |
| sunflower lecithin | 0.5% |
| pea protein | 3% |
| water | 66% |
| | 100% |

This formula was too viscous and not processable. The amount of solids was too high.

It should be understood of course that the specific forms of the invention herein illustrated and described are intended to be representative only, as certain changes may be made therein without departing from the clear teaching of the disclosure. Accordingly, reference should be made to the appended claims in determining the full scope.

1-18. (canceled)

19. A frozen confection comprising:
6-10 wt % saturated oil selected from the group of coconut oil, cocoa butter, illipe, shea, palm oil, palm kernel oil, sal and mixtures thereof;
0.5-4 wt % vegetable protein selected from the group of pea protein, chickpea beans, soy protein, wheat protein, cotton seed protein, sunflower seed, oat protein, lentil protein, sesame seed protein, broad bean protein, horse bean protein, alfalfa protein, clover protein, rice protein, tapioca protein, potato protein, carob protein and corn protein;
1-8 wt % nut solids selected from the group of almonds, cashews, pecans, peanuts, macademia nuts, brazil nuts, pine nuts, butternuts, hazelnuts, walnuts, beechnuts, hickory nuts, chestnuts, pistachios and mixtures thereof;
10-30 wt % sugar solids;
0.1-1 wt % emulsifier; and
0.1-1 wt % stabilizer, the frozen confection being essentially free of dairy ingredients, said frozen confection being solidified under freezing conditions to a hardpack or pumpable consistency which is not fluid or semi-fluid and having an ice content of more than 15% but less than 45% when measured at −18° C., the frozen confection being a water-continuous emulsion.

20. The frozen confection according to claim 19 wherein the vegetable protein comprises pea protein.

21. The frozen confection according to claim 19 wherein the nut solids comprise almond solids.

22. The frozen confection according to claim 19 essentially free of soy protein.

23. A frozen confection comprising:
6-10 wt % saturated oil;
0.2-4 wt % lentil protein;
1-8 wt % nut solids;
10-30 wt % sugar solids;
0.1-1wt % emulsifier; and
0.1-1wt % stabilizer, the frozen confection being essentially free of dairy ingredients.

24. The frozen confection according to claim 19 having an overrun of from 20-40.

25. The frozen confection according to claim 19 having from 1 to 2 wt % vegetable protein.

26. The frozen confection according to claim 19, wherein the confection is essentially free of hydrogenated fats.

27. The frozen confection according to claim 19 wherein the vegetable protein is selected from the group of pea protein, wheat protein, cotton seed protein, sunflower seed, oat protein, lentil protein, sesame seed protein, alfalfa protein, clover protein, rice protein, tapioca protein, potato protein, carob protein and corn protein.

28. The frozen confection according to claim 23 having a fine microstructure after hardening to below −18° C. of between 20 and 150 um.

29. The frozen confection according to claim 19, having a fine microstructure after hardening to below −18° C. with an average bubble diameter between 20 and 200 um.

30. The frozen confection according to claim 19 wherein the base confection is essentially free of protein hydrolyzates.

31. The frozen confection according to claim 19 comprising from 0.5 to 2 wt % vegetable protein.

32. The frozen confection according to claim 19 wherein the nut solids are added to a liquid base mix before freezing in the form of ground nuts, nut paste, or nut butter.

33. The frozen confection according to claim 19 comprising from 0.5 to 2 wt % pea protein.
